(19) United States
(12) Patent Application Publication
(10) Pub. No.: US 2025/0184051 A1
(43) Pub. Date: Jun. 5, 2025

(54) BASE STATION APPARATUS THAT REALIZES REDUCTION IN POWER CONSUMPTION IN COMMUNICATION, TERMINAL APPARATUS, AND CONTROL METHOD

(71) Applicant: KDDI CORPORATION, Tokyo (JP)

(72) Inventors: Yanwei LI, Tokyo (JP); Hiroki TAKEDA, Tokyo (JP); Masahito UMEHARA, Tokyo (JP); Yasuki SUZUKI, Tokyo (JP)

(21) Appl. No.: 19/043,879

(22) Filed: Feb. 3, 2025

Related U.S. Application Data
(63) Continuation of application No. PCT/JP2023/005168, filed on Feb. 15, 2023.

(30) Foreign Application Priority Data
Aug. 9, 2022 (JP) 2022-127311

(51) Int. Cl. H04L 5/00; H04W 72/0446; H04W 72/0453

(52) U.S. Cl. CPC H04L 5/001; H04W 72/0446; H04W 72/0453

(57) ABSTRACT

A base station apparatus in a wireless communication network that provides a terminal apparatus with a communication service with use of at least one of a plurality of component carriers (CC) is provided. In a case where system information that has been stopped from being transmitted on a second CC is transmitted on a first CC, the base station apparatus notifies the terminal apparatus, on the second CC, of information of a wireless resource in which the system information for the second CC is transmitted, the first CC and the second CC being included among the plurality of CCs.

### CROSS-REFERENCE TO RELATED APPLICATION(S)

This application is a continuation of International Patent Application No. PCT/JP2023/005168 filed on Feb. 15, 2023, which claims priority to and the benefit of Japanese Patent Application No. 2022-127311 filed on Aug. 9, 2022, the entire disclosures of which are incorporated herein by reference.

### BACKGROUND OF THE INVENTION

### Field of the Invention

The present invention relates to a control technique for realizing wireless communication with low power consumption.

### Description of the Related Art

In the 3rd Generation Partnership Project (3GPP®), suppression of power consumption in a network has been discussed as an important issue. 3GPP Written Contributions, R1-2203173 proposes that transmission of at least a part of a Synchronization Signal/Physical Broadcast Channel block (SSB) and System Information Block Type1 (SIB1), which have been constantly transmitted on each component carrier conventionally, is stopped on a part of the component carriers (CCs). 3GPP Written Contributions, R1-2203173 proposes that information for connection to the CC on which transmission of at least a part of SSB and SIB1 is stopped is transmitted on another CC.

The present invention provides a technique that makes it possible to, in a case where transmission of at least a part of SSB and SIB1 is stopped on a specific CC, efficiently collect such information that has been stopped from being transmitted for the purpose of standby and establishment of connection on this specific CC.

### SUMMARY OF THE INVENTION

According to one aspect of the present invention, there is provided a base station apparatus in a wireless communication network that provides a terminal apparatus with a communication service with use of at least one of a plurality of component carriers (CC), the base station apparatus comprising: a notification unit configured to, in a case where system information that has been stopped from being transmitted on a second CC is transmitted on a first CC, notify the terminal apparatus, on the second CC, of information of a wireless resource in which the system information for the second CC is transmitted, the first CC and the second CC being included among the plurality of CCs.

According to one aspect of the present invention, there is provided a terminal apparatus in a wireless communication network that provides the terminal apparatus with a communication service with use of at least one of a plurality of component carriers (CC), the terminal apparatus comprising: a reception unit configured to, in a case where a base station apparatus in the wireless communication network transmits on a first CC system information that has been stopped from being transmitted on a second CC, receive on the second CC information of a wireless resource in which the system information for the second CC is transmitted, and receive the system information for the second CC on the first CC on a basis of the information of the wireless resource, the first CC and the second CC being included among the plurality of CCs.

Further features of the present invention will become apparent from the following description of exemplary embodiments with reference to the attached drawings.

### BRIEF DESCRIPTION OF THE DRAWINGS

FIG. 1 is a diagram showing an exemplary configuration of a wireless communication network;

FIG. 2 is a diagram showing an outline of a flow of processing;

FIG. 3 is a diagram showing an outline of a flow of processing;

FIG. 4A is a diagram showing examples of formats of signals for transmitting resource information;

FIG. 4B is a diagram showing examples of formats of signals for transmitting resource information;

FIG. 5 is a diagram showing an exemplary hardware configuration of apparatuses;

FIG. 6 is a diagram showing an exemplary functional configuration of a base station apparatus;

FIG. 7 is a diagram showing an exemplary functional configuration of a terminal apparatus; and

FIG. 8 is a diagram showing an example of a flow of processing executed in a wireless communication network.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Network Configuration

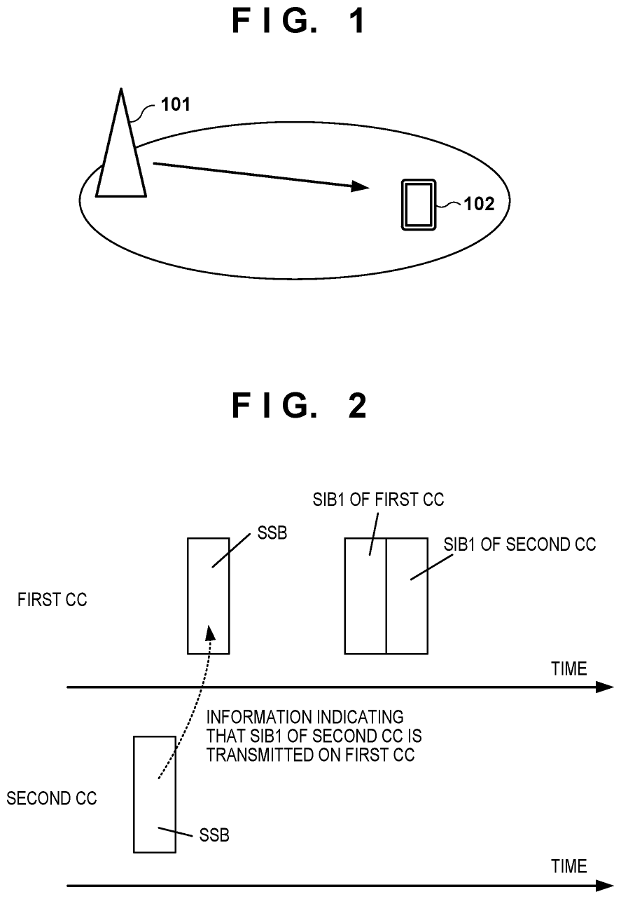

FIG. 1 shows an exemplary configuration of a wireless communication network according to the present embodiment. This wireless communication network is a cellular communication system conforming with, for example, the cellular communication standards of the 3rd Generation Partnership Project (3GPP®). The wireless communication network is configured to include, for example, a base station apparatus 101 and a terminal apparatus 102. The base station apparatus 101 provides a wireless communication service to the terminal apparatus 102 using, for example, one or more of a plurality of component carriers (CCs). Note that FIG. 1 only shows one base station apparatus 101 and one terminal apparatus 102 to simplify the description; however, naturally, two or more base station apparatuses and terminal apparatuses may exist. Note that the base station apparatus 101 may, for example, provide a plurality of CCs using wireless transmission/reception devices placed at the same position, or provide a plurality of CCs using wireless transmission/reception devices placed at different positions. Also, the base station apparatus 101 may provide a wireless communication service using a plurality of CCs in coordination with another base station apparatus. Note that in a case where a plurality of base station apparatuses operate in coordination with one another, they can be configured to perform communication for exchanging control information with one another via, for example, an Xn interface, an S1 interface, or the like.

Conventionally, the base station apparatus 101 is configured to transmit a Synchronization Signal/Physical Broadcast Channel block (SSB) and System Information Block Type1 (SIB1) on each of a plurality of CCs. That is to say, on each CC, SSB and SIB1 are always transmitted periodically. This causes the base station apparatus 101 to consume power for transmission of these SSB and SIB1.

In contrast, by transmitting connection information (e.g., a Master Information Block (MIB) and SIB1) for a first CC on a second CC different from the first CC without transmitting SSB and SIB1 on the first CC as described in 3GPP Written Contributions, R1-2203173, power consumption in the second CC can be reduced. On the other hand, in this case, when the terminal apparatus 102 searches for a connection destination on the second CC, because MIB, SIB1, and the like are not transmitted on the second CC, the terminal apparatus 102 cannot be on standby or establish connection on the second CC when only this second CC has been observed. That is to say, unless the terminal apparatus 102 observes the first CC on which MIB and SIB1 of the second CC are transmitted, the terminal apparatus 102 cannot obtain information of the second CC, and cannot be on standby or establish connection. Here, the base station apparatus 101 may be expected to provide communication on many CCs. In this case, the terminal apparatus 102 may end up in observing each CC to specify, from among these many CCs, the first CC on which MIB and SIB1 for the second CC are transmitted. In view of this, in a case where the number of CCs is large, it may take a long time for the terminal apparatus 102 to obtain information of the second CC. Furthermore, even in a case where the number of CCs is small, the terminal apparatus 102 may require a long period of time to specify the wireless resource (frequency and time resource) of the first CC in which MIB and SIB1 of the second CC are transmitted.

In the present embodiment, the base station apparatus 101 provides a method that, with regard to the second CC that skips transmission of at least a part of system information, such as MIB and SIB1, allows for specification of a CC and a wireless resource in which these MIB and SIB1 can be obtained. This allows the terminal apparatus 102 to promptly obtain the information that is not transmitted on the second CC, such as MIB and SIB1 of the second CC, and allows standby and connection establishment on the second CC to be efficiently conducted.

For example, an arrangement is made to transmit, on the second CC, information that allows for specification of the wireless resource in which MIB and SIB1 for the second CC are transmitted. In one example, even in a case where MIB and SIB1 are not transmitted on the second CC, synchronization signals (a primary synchronization signal (PSS) and a secondary synchronization signal (SSS)) are transmitted on the second CC for establishing timing synchronization. The base station apparatus 101 can transmit the information that allows for specification of the wireless resource in which MIB and SIB1 are transmitted, together with such synchronization signals, on the second CC.

For example, it is assumed that the base station apparatus 101 skips transmission of SIB1, but does not skip transmission of MIB, on the second CC. In this case, as shown in FIG. 2, the base station apparatus 101 can provide, via MIB of the second CC, a notification indicating that information related to SIB1 of the second CC is transmitted on the first CC. In one example, this notification can be provided via PDCCH-configsib1 included within MIB. Then, the base station apparatus 101 can transmit, on the first CC, information indicating the frequency and time resource within the first CC in which SIB1 of the second CC is transmitted. This information can be provided as information of “control resource set”, “search space set”, and the like defined in the standards of the fifth generation (5G), for example. In this way, the terminal apparatus 102 can specify the wireless resource in which SIB1 for the second CC is transmitted by checking the first CC after checking MIB on the second CC. Then, the terminal apparatus 102 can be on standby and establish connection on the second CC by receiving SIB1 of the second CC in this wireless resource. Note that handling of other types of system information of SIB1 will be described later.

Note that the information which is transmitted on the second CC and which indicates that the information related to SIB1 of the second CC is transmitted on the first CC can be, for example, a physical cell identifier (PCI) of the first CC, information indicating a band of the first CC, and information of a frequency position at which SIB1 for the second CC is transmitted. In one example, in a case where the reference frequency of a CC, such as the central frequency, is associated with the PCI in advance, the terminal apparatus 102 can specify the reference frequency of the first CC using information of the PCI of the first CC. Also, the frequency position at which SIB1 for the second CC is transmitted can be designated by an absolute radio-frequency channel number (ARFCN) and a global synchronization channel number (GSCN). By accessing the frequency and band specified by such information, the terminal apparatus 102 can first decode MIB and SIB1 on the first CC. Then, the terminal apparatus 102 specifies the wireless resource which is designated by these MIB, SIB1, and the like on the first CC and in which SIB1 of the second CC is transmitted, and refers to this wireless resource; in this way, SIB1 of the second CC can be decoded. Consequently, the terminal apparatus 102 can efficiently obtain information of SIB1 for the second CC by accessing the first CC without accessing frequencies other than the frequencies associated with the first CC. Furthermore, the frequency position at which SIB1 for the second CC is transmitted may be designated as a frequency offset from a predetermined reference frequency. For example, “the frequency position at which SIB1 for the second CC is transmitted=the predetermined reference frequency+the frequency offset” can be designated. Here, the predetermined reference frequency can be the central frequency of the band in which synchronization signals and MIB are transmitted on the first CC or the second CC. Also, this predetermined reference frequency may be a lower limit value or an upper limit value of carrier frequencies of the first CC. Furthermore, a frequency other than these frequencies may be used as the predetermined reference frequency. Moreover, the amount of the frequency offset may be, for example, a value indicating a frequency width, or may be denoted by the amount of resource blocks. In addition, the amount of the frequency offset can be denoted by one of a positive value and a negative value.

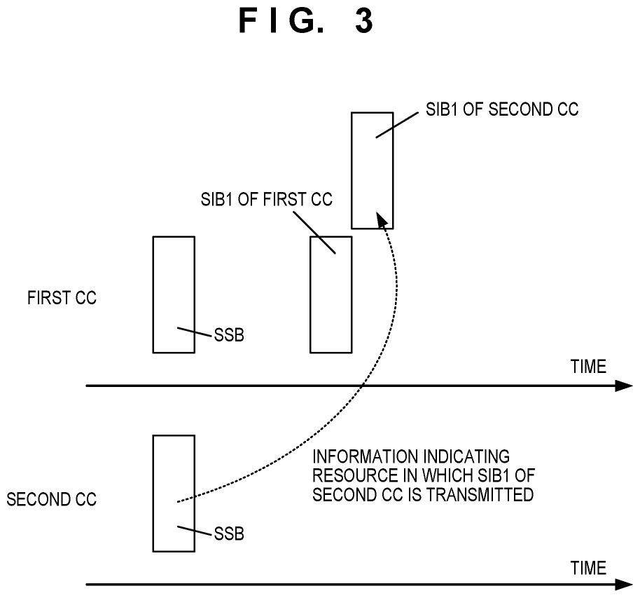

In one example, the detailed frequency resource in which SIB1 is transmitted may be specified by the above-described information. For example, as shown in FIG. 3, the base station apparatus 101 can notify the terminal apparatus 102 of information that allows for specification of a frequency range in which SIB1 of the second CC is transmitted from among frequency ranges of the first CC. This information may be information that directly designates the frequency resource in which SIB1 of the second CC is transmitted, or may be information that designates an offset value from the reference frequency. Furthermore, the base station apparatus 101 may notify the terminal apparatus 102 of information of the timing of transmission of SIB1 on the second CC. This information of the timing can be, for example, a value of a time offset from the time resource on the second CC in which the information designating the frequency resource for transmission of SIB1 on the first CC is transmitted, to the time resource in which SIB1 for the second CC is transmitted. Also, the information of the timing may be information that directly designates a time resource, such as a frame number and information of time. For example, the information may indicate whether the time resource on the second CC in which the information designating the frequency resource for transmission of SIB1 on the first CC is transmitted, and the time resource in which SIB1 for the second CC is transmitted, exist within the same wireless frame. In a case where both resources exist within the same frame, the time offset can be offset information composed of a slot number and a symbol number, rather than a frame number, in one example. In this case, the frame number may be omitted, and the slot number and the symbol number may be directly designated. In a case where both resources do not exist within the same wireless frame, the frame number, the slot number, and the symbol number can be directly designated, or designated by an offset. In a case where transmission is performed under difference frame numbers and the same slot number and symbol number in both resources, only the frame numbers may be designated, and the slot number and the symbol number may be omitted. With use of the foregoing pieces of information, for example, when the terminal apparatus 102 has obtained, on the second CC, information of the wireless resource in which SIB1 for the second CC is transmitted, it can directly refer to the wireless resource in which SIB1 related to the second CC is transmitted among the wireless resources included in the first CC. In this case, it is no longer required for MIB, SIB1, and the like of the first CC to designate the wireless resource in which SIB1 of the second CC is transmitted. Furthermore, the terminal apparatus 102 no longer need to decode these MIB and SIB1 of the first CC, and becomes able to efficiently be on standby or establish connection on the second CC. Note that in a case where the first CC and the second CC are in timing synchronization with each other, the terminal apparatus 102 can also skip establishment of time synchronization in a downlink with use of synchronization signals on the first CC.

Note that the frequency resource and the time resource in which SIB1 of the second CC is transmitted may be designated by PDCCH transmitted on the second CC or the first CC. In this case, for example, under the standards of the fifth generation (5G), the terminal apparatus can receive PDCCH by specifying the frequency resource and the time resource in which PDCCH is transmitted on the basis of information designated by “control resource set” and “search space set” included in PDCCH-configsib1 of SIB1. Then, the terminal apparatus specifies the frequency and the time resource of PDSCH via which SIB1 is transmitted from information included in PDCCH. In a case where PDCCH is transmitted on the second CC, “control resource set” and “search space set” included in MIB of the second CC indicate the frequency and the time resource of PDCCH transmitted on the second CC, and information included in this PDCCH can indicate that SIB1 is transmitted via PDSCH transmitted on the first CC. In a case where PDCCH is transmitted on the first CC, “control resource set” and “search space set” included in MIB of the second CC indicate the frequency and the time resource of PDCCH transmitted on the first CC, and information included in this PDCCH can indicate that SIB1 is transmitted via PDSCH transmitted on the first CC.

Note that the above-described example pertains to a case where MIB is transmitted, but transmission of SIB1 is skipped, on the second CC. In addition, transmission of MIB may be skipped. In this case, in addition to SIB1 for the second CC according to the above-described example, MIB is transmitted on the first CC. Here, the base station apparatus 101 transmits information of the wireless resource in which MIB and SIB1 are transmitted, in place of MIB according to the above-described example, on the second CC. The information of the wireless resource transmitted here is similar to that according to the above-described example. That is to say, for example, a PCI of the first CC, information indicating a band of the first CC, ARFCN and GSCN of the first CC, an offset value from the reference frequency, and the like can be transmitted as the information of the wireless resource in which MIB and SIB1 for the second CC are transmitted. When MIB of the second CC is transmitted on the first CC in the foregoing manner, this MIB can be transmitted through PBCH of the first CC. As the transmission cycle of PBCH is shorter than, for example, that of SIB1, the terminal apparatus 102 can receive MIB of the second CC early compared to a case where the content of MIB is included within SIB1 of the first CC, or a case where MIB is transmitted in the wireless resource designated by SIB1 of the first CC. Furthermore, MIB of the second CC may be transmitted either by being included in SIB1 of the first CC, or in the wireless resource designated by SIB1 of the first CC. In this way, it is no longer required to change MIB of the first CC, and a terminal apparatus that is based on, for example, a legacy system can ignore this MIB of the second CC, thereby suppressing an influence on the entire system.

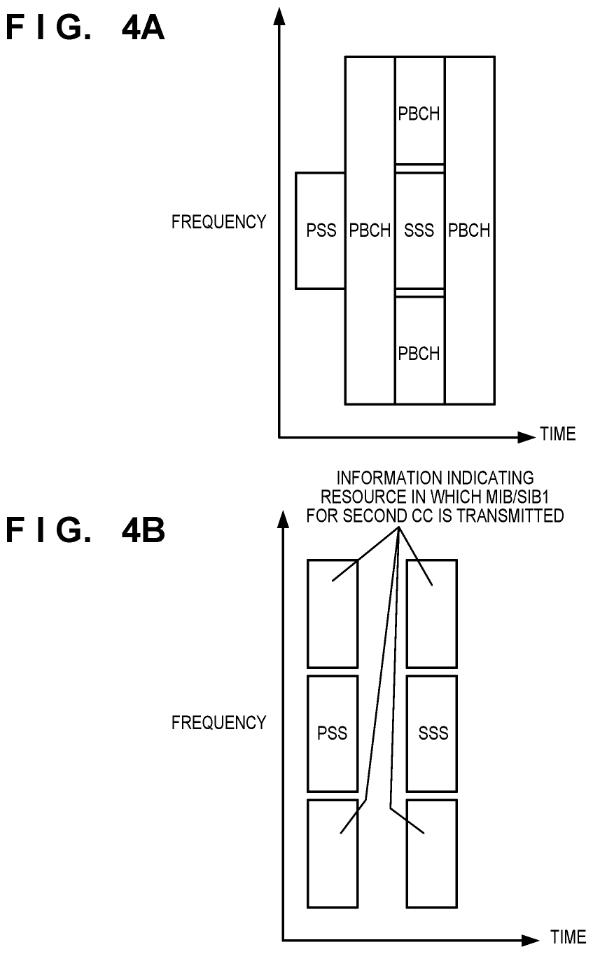

Note that the base station apparatus 101 can transmit the information that designates the wireless resource in which MIB and SIB1 for the second CC are transmitted, with use of the wireless resource that has conventionally been used to transmit PBCH on the second CC (in a case where MIB is transmitted, the wireless resource in which this MIB is transmitted). However, no limitation is intended by this; for example, the information that designates the wireless resource in which MIB and SIB1 for this second CC are transmitted may be transmitted in orthogonal frequency division multiplexing (OFDM) symbols in which synchronization signals (PSS/SSS) are transmitted. For example, as shown in FIG. 4A, PSS is configured so that it is transmitted only in a part of frequency ranges (e.g., subcarriers with subcarrier numbers 56 to 182) among the OFDM symbols, and it does not use other frequency ranges. For this reason, as shown in FIG. 4B, other frequency ranges can be used for transmission of the information that designates the wireless resource in which MIB and SIB1 for the second CC are transmitted. Also, as shown in FIG. 4A, SSS is also transmitted only in a part of frequency ranges among the OFDM symbols, and other frequency ranges are used for transmission of announcement signals (PBCH). These resources that have conventionally been used for transmission of PBCH can also be used for transmission of the information that designates the wireless resource in which MIB and SIB1 for the second CC are transmitted, as shown in FIG. 4B. As a result of transmitting information with use of a frequency range that is not used in transmission of the synchronization signals among the OFDM symbols that are the same as at least one of PSS and SSS, the OFDM symbols in which only PBCH have conventionally been transmitted need not be transmitted. This can further reduce power consumption in the network.

Note that the base station apparatus 101 may transmit, on the second CC, identification information indicating that at least a part of system information, such as SIB1 (and MIB in some cases) of the second CC, is not transmitted on the second CC. In a case where the terminal apparatus 102 has received this identification information, it checks, on the second CC, information of the wireless resource in which this SIB1 is transmitted. That is to say, based on this identification information, the terminal apparatus 102 can switch between processing for executing normal decoding of MIB and SIB1, and processing for checking information of the wireless resource of another CC or the like in which SIB1 (and MIB in some cases) is transmitted. Furthermore, in a case where MIB and SIB1 for the second CC are transmitted on the first CC, the base station apparatus 101 may transmit identification information indicating that these pieces of information for the second CC are transmitted. In this way, in a case where the terminal apparatus 102 has an intention to use the second CC while on standby or connecting on the first CC, it can obtain system information of the second CC simply by receiving signals transmitted on the first CC. Therefore, the terminal apparatus 102 is no longer required to, for example, take the steps of observing signals on the second CC and decoding, based on information transmitted on this second CC, information of the first CC again to obtain system information of the second CC. This allows the terminal apparatus 102 to efficiently obtain the system information of the second CC.

Note that SIB1 includes parameters necessary for accessing cells, information for scheduling other system information, and information of settings related to universal access restrictions for cells. Here, SIB1 for the second CC transmitted on the first CC may be transmitted in such a manner that it is dispersed to a plurality of different wireless resources. Similarly, in a case where MIB is transmitted on the first CC, MIB may also be transmitted in such a manner that it is dispersed to a plurality of different wireless resources. In this way, SIB1 of the second CC can be transmitted on the first CC in accordance with the availability of wireless resources, thereby allowing MIB and SIB1 of the second CC to be transmitted without exerting a large influence on communication on the first CC. Note that in this case, a notification indicating, for example, the position of a single first wireless resource that arrives at the earliest timing among the plurality of wireless resources can be provided on the second CC. The terminal apparatus 102 obtains information by accessing the first wireless resource in accordance with this notification. Here, in the first wireless resource, a notification indicating the position of a second wireless resource that arrives at the second earliest timing among the plurality of wireless resources can be provided. After obtaining information in the first wireless resource, the terminal apparatus 102 obtains information by accessing the second wireless resource indicated by the notification. Then, in the second wireless resource, a notification indicating the position of a third wireless resource that arrives at the third earliest timing among the plurality of wireless resources can be provided. As described above, after the position of one wireless resource has been designated, the terminal apparatus 102 accesses this designated resource, and consequently, a resource that is to be accessed next is designated in a sequential manner; this can reduce the amount of information of the positions of wireless resources to be notified on the second CC. Note that the positions of two or more (a part or all) of the plurality of wireless resources may be collectively indicated by a notification provided on the second CC.

The base station apparatus 101 according to the above-described example transmits, on one CC, system information related to a plurality of CCs. Note that the system information can include other types of SIB, such as SIB2, in addition to the above-described MIB and SIB1. Here, when the base station apparatus 101 constantly provides a notification indicating such system information of a plurality of CCs on the first CC, there may be a case where the first CC has a shortage of wireless resources that can be used for user data. In this case, the base station apparatus 101 may transmit system information of the second CC (or related to another CC) notified on the first CC only when it has received a message requesting this system information from the terminal apparatus 102. Note, it is possible that MIB and SIB1 may be constantly transmitted, and only other types of SIB may be transmitted based on such a request.

The base station apparatus 101 can notify the terminal apparatus 102 of scheduling information for SIB of the second CC, in addition to scheduling information for SIB of the first CC, with use of a frequency band of the first CC. In this case, as one example, the terminal apparatus 102 is notified of scheduling information for SIB with use of SI-SchedulingInfo defined by the 3GPP. The terminal apparatus 102 determines whether SIBs of the second CC include an SIB which is not to be announced according to the notification of SI-SchedulingInfo (for which the notification indicates “notBroadcasting”). Then, in a case where such an SIB is included, the terminal apparatus 102 transmits an

RRCSystemInfoRequest, which is a request message for requesting this SIB. In a case where the base station apparatus 101 has received this request message, it transmits the requested SIB via a System Information massage. In this way, the terminal apparatus 102 can receive the SIB for which it has requested the base station apparatus 101. Note that regarding an SIB which is to be announced according to the notification of SI-SchedulingInfo (for which the notification indicates “Broadcasting”) among SIBs of the second CC, this SIB is announced on the first CC, and thus the terminal apparatus 102 can received this SIB.

Using a SchedulingInfoList included in SI-SchedulingInfo, the terminal apparatus 102 can designate which SIB is requested to be provided. A bitmap list indicating whether a plurality of SIBs need to be provided is transmitted using the SchedulingInfoList. In the bitmap, “1” indicates that an SIB corresponding to this bit is requested to be provided, whereas “0” indicates that an SIB corresponding to this bit is not requested to be provided. As one example, assume that the first bit, the second bit, and the third bit in the bitmap correspond to SIB2, SIB3, and SIB4, respectively. Then, in a case where the terminal apparatus 102 requests all of SIB2, SIB3, and SIB4, it transmits an RRCSystemInfoRequest that includes a bitstream “111” as the SchedulingInfoList to the base station apparatus 101. Also, in a case where the terminal apparatus 102 requests SIB4 to be provided but does not request SIB2 and SIB3 to be provided, it transmits an RRCSystemInfoRequest that includes a bitstream “001” as the SchedulingInfoList to the base station apparatus 101.

Furthermore, when the terminal apparatus 102 requests a provision of SIB with use of an RRCSystemInfoRequest, it can give notice of a PCI in this RRCSystemInfoRequest in order to designate to which CC (cell) the requested SIB pertains. Conventionally, in a case where SIB has been requested on the first CC, SIB related to the first CC is received. In contrast, in a case where SIBs of the first CC and the second CC (and still another CC where necessary) are transmitted on the first CC as in the present embodiment, the terminal apparatus 102 can explicitly notify the base station apparatus 101 of to which CC the requested SIB pertains.

Note that regarding a communication parameter si-RequestConfig related to, for example, a random-access procedure (RACH) at the time of transmission of an RRCSystemInfoRequest, the same communication parameter si-RequestConfig can be used both in a case where SIB of the first CC is requested and in a case where SIB of the second CC is requested. Note that this is an example, and the used communication parameter may differ between a case where SIB of the first CC is requested and a case where SIB of the second CC is requested. Furthermore, scheduling information SI-SchedulingInfo for SIB of the second CC, as well as the communication parameter si-RequestConfig at the time of transmission of an RRCSystemInfoRequest requesting SIB of the second CC, may be transmitted on the first CC, or may be transmitted on the second CC. Note that all of them may be transmitted on one of the first CC and the second CC, or they may be transmitted in such a manner that they are dispersed to a plurality of CCs, for example, a part thereof them may be transmitted on the first CC, whereas the remaining information may be transmitted on the second CC.

Also, SI-SchedulingInfo of the first CC may designate transmission timings of not only SIB of the first CC, but also SIB of the second CC. In this case, the first to the third elements in a SchedulingInfoList can respectively correspond to SIB2 to SIB4 of the first CC, and the fourth to the sixth elements therein can respectively correspond to SIB2 to SIB4 of the second CC. Also, si-WindowPosition and si-Periodicity in each List designate the transmission timing of each of SIBs of the first CC and the second CC. Also, in this case, the SchedulingInfoList may include MIB of the second CC and SIB of the second CC. Furthermore, the base station apparatus 101 may notify the terminal apparatus 102 of notBroadcasting with respect to SIB of the second CC so that SIB is to be obtained on demand. In a case where the base station apparatus gives notice of notBroadcasting, the terminal apparatus requests the base station apparatus for MIB of the second CC or SIB of the second CC that are rendered notBroadcasting, and then receives transport blocks designated by the above-described si-WindowPosition and si-Periodicity in the List. As a result, the terminal apparatus can receive desired MIB or SIB.

Furthermore, the terminal apparatus 102 can skip the reception of SIB in a case where systemInformationAreaID, which is an announcement information area identifier included in schedule information for SIB of the second CC, matches an announcement information area identifier of SIB information that is already held therein. In a case where the announcement information area identifier of SIB of the second CC has the same value as the announcement information area identifier of SIB of the first CC, the terminal apparatus 102 can skip the obtainment of SIB of the second CC by obtaining SIB of the first CC. Also, in a case where the announcement information area identifier of SIB of the second CC is different from the announcement information area identifier of SIB of the first CC, the terminal apparatus 102 can obtain only SIB of the second CC, and skip the obtainment of SIB of the first CC.

### Apparatus Configuration

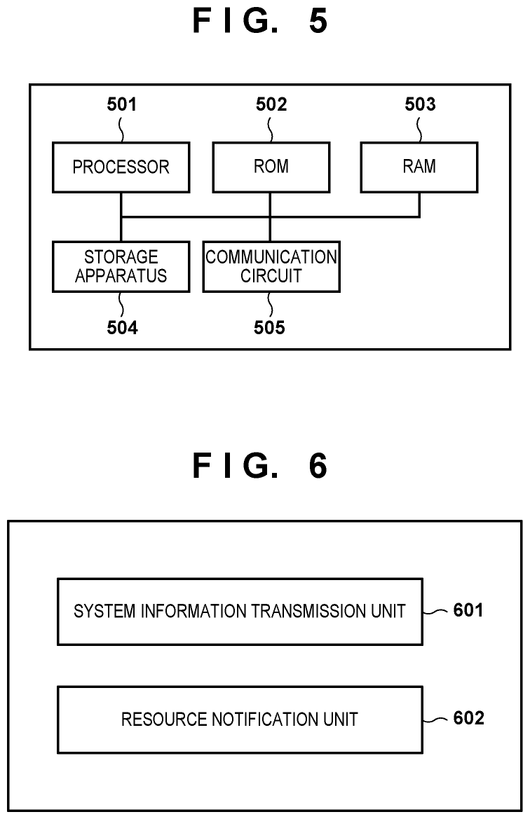

Using FIG. 5, a description is now given of exemplary hardware configurations of the base station apparatus and the terminal apparatus. In one example, the base station apparatus and the terminal apparatus are configured to include a processor 501, a ROM 502, a RAM 503, a storage apparatus 504, and a communication circuit 505. The processor 501 is a computer configured to include one or more processing circuits, such as a general-purpose central processing unit (CPU) and an application-specific integrated circuit (ASIC), and executes entire processing of the apparatus and each type of processing described above by reading out and executing programs stored in the ROM 502 or the storage apparatus 504. The ROM 502 is a read-only memory that stores information of programs related to processing executed by the base station apparatus and the terminal apparatus, various types of parameters, and the like. The RAM 503 is a random-access memory that functions as a working space when the processor 501 executes programs, and stores temporary information. The storage apparatus 504 is composed of, for example, an attachable and removable external storage apparatus or the like. The communication circuit 505 is composed of, for example, a circuit for LTE or 5G wireless communication. Note that although FIG. 5 shows one communication circuit 505, the base station apparatus and the terminal apparatus can include a plurality of communication circuits. For example, the base station apparatus and the terminal apparatus can include an antenna shared by wireless communication circuits for LTE and 5G. Note that the base station apparatus and the terminal apparatus may include an antenna for LTE and an antenna for 5G separately. Also, the base station apparatus can further include a wired communication circuit that is used when communicating with nodes of another base station apparatus and a core network. Furthermore, the terminal apparatus may include a communication circuit for another wireless communication network, such as a wireless LAN. Note that the base station apparatus and the terminal apparatus may include separate communication circuits 505 respectively for a plurality of usable frequency bands, or may include a shared communication circuit 505 for at least a part of these frequency bands.

FIG. 6 shows an exemplary functional configuration of the base station apparatus. The base station apparatus includes, for example, a system information transmission unit 601 and a resource notification unit 602 as its functions. Note that FIG. 6 shows only the functions that are particularly relevant to the present embodiment, and the illustration of various types of other functions that can be included in the base station apparatus is omitted. For example, the base station apparatus naturally has other functions that are generally included in LTE and 5G base station apparatuses. Also, the functional blocks of FIG. 6 are schematically shown; the functional blocks may be realized in an integrated manner, or each functional block may be further divided. Furthermore, each function of FIG. 6 may be realized by, for example, the processor 501 executing programs stored in the ROM 502 or the storage apparatus 504, or may be realized by, for example, a processor included within the communication circuit 505 executing predetermined software. Note that regarding the details of processing executed by each functional unit, the following does not describe the aforementioned details, and describes an overview of only general functions thereof.

The system information transmission unit 601 transmits MIB and SIB1 for the first CC on the first CC. Also, the system information transmission unit 601 can transmit other SIBs (e.g., SIB2) for the first CC. Furthermore, the system information transmission unit 601 transmits, on the first CC, system information such as SIB1 (and MIB where necessary) that has been stopped from being transmitted on the second CC, which is different from the first CC. Moreover, the system information transmission unit 601 can transmit other SIBs for the second CC. Note that other SIBs may be transmitted only in a case where a request from the terminal apparatus has been received, or may be constantly transmitted. Also, the base station apparatus need not necessarily transmit signals on the first CC. That is to say, in a case where another base station apparatus that operates in coordination with the base station apparatus transmits signals on the first CC, the other base station apparatus may transmit system information on the first CC, and the base station apparatus may not transmit system information. In a case where system information (e.g., MIB, SIB1, and other SIBs) that has been stopped from being transmitted on the second CC is transmitted on another CC, the resource notification unit 602 notifies the terminal apparatus of information of the resource in which this system information is transmitted. Note that although this notification can be performed through, for example, broadcast, at least a part thereof may be performed through unicast or multicast. As stated earlier, the information of the resource can be, for example, information indicating the first CC on which system information for the second CC is transmitted, information of the specific frequency and time resource within the first CC, and the like. Notified information is as described above, and thus a description thereof is omitted here.

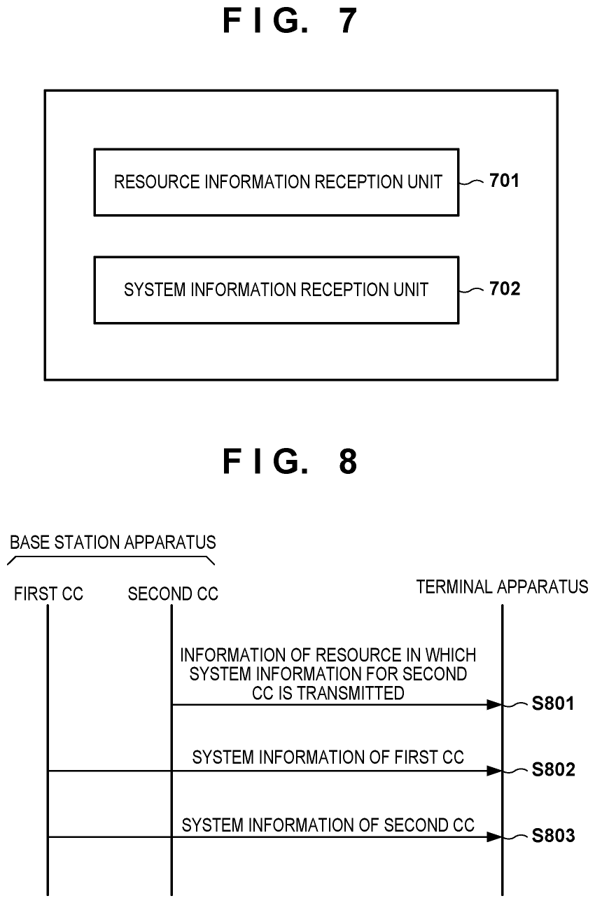

FIG. 7 shows an exemplary functional configuration of the terminal apparatus. The terminal apparatus includes, for example, a resource information reception unit 701 and a system information reception unit 702 as its functions. Note that FIG. 7 shows only the functions that are particularly relevant to the present embodiment, and the illustration of various types of other functions that can be included in the terminal apparatus is omitted. For example, the terminal apparatus naturally has other functions that are generally included in LTE and 5G terminal apparatuses. Also, the functional blocks of FIG. 7 are schematically shown; the functional blocks may be realized in an integrated manner, or each functional block may be further divided. Furthermore, each function of FIG. 7 may be realized by, for example, the processor 501 executing programs stored in the ROM 502 or the storage apparatus 504, or may be realized by, for example, a processor included within the communication circuit 505 executing predetermined software. Note that regarding the details of processing executed by each functional unit, the following does not describe the aforementioned details, and describes an overview of only general functions thereof. Note, it is assumed here that the terminal apparatus has executed, for example, detection of synchronization signals on the second CC, and is attempting to obtain system information for the second CC.

In a case where transmission of system information is stopped on the second CC, the resource information reception unit 701 receives, on the second CC, information of the resource in which system information for this second CC is transmitted from the base station apparatus. Based on the information of the resource received by the resource information reception unit 701, the system information reception unit 702 refers to the first CC on which the system information for the second CC is transmitted, and receives the system information for the second CC. Note that the terminal apparatus may be expected to support only the second CC. In this case, the terminal apparatus cannot observe the first CC. Therefore, the terminal apparatus that cannot observe the first CC determines that it cannot be on standby or establish connection on the second CC on which the transmission of system information is stopped. Then, in a case where the terminal apparatus has obtained information of, for example, a result of measurement of reference signals on the second CC on which the terminal apparatus cannot be on standby and the like as a result of the determination, the terminal apparatus discards this information, and searches for another cell that uses the same frequency band.

### Flow of Processing

Next, an example of a flow of processing executed in the wireless communication network will be described using FIG. 8. Note that as the details of processing steps explained below are as described above, the following simply describes an outline of the flow of processing. Note, it is assumed in the present exemplary processing that one base station apparatus can use both of the first CC and the second CC.

In the present exemplary processing, the base station apparatus has stopped transmission of system information (SIB1 and MIB) on the second CC, and announces information of the resource in which this system information is transmitted (step S801). The terminal apparatus receives this information when receiving, for example, synchronization signals on the second CC. Then, based on this received information, the terminal apparatus specifies that, for example, system information for the second CC is transmitted on the first CC. Thereafter, based on the information designated in step S801, the terminal apparatus observes the first CC. The terminal apparatus can, for example, receive SSB on the first CC and obtain system information of the first CC (step S802). Note that the terminal apparatus need not receive the system information of the first CC in a case where, for example, the frame timings of the first CC and the second CC are in synchronization with each other, and the detailed information of the frequency and time resource that is used in transmission of the system information for the second CC has been received in step S801. Thereafter, based on the information designated in step S801, the terminal apparatus receives the system information for the second CC on the first CC (step S803). Note that in a case where, for example, there is further system information that has not been announced and it is necessary to receive this further system information, the terminal apparatus requests this further system information to be provided on the first CC. Then, the terminal apparatus can receive, on the first CC, the further system information transmitted from the base station apparatus in response to this request.

In this way, in a case where transmission of system information is stopped on the second CC and this system information is transmitted on another CC (the first CC), the terminal apparatus can efficiently receive this system information of the second CC. This makes it possible to contribute to Goal 9 of Sustainable Development Goals (SDGs) led by the United Nations, which is to “build resilient infrastructure, promote inclusive and sustainable industrialization, and foster innovation”.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A base station apparatus in a wireless communication network that provides a terminal apparatus with a communication service with use of at least one of a plurality of component carriers (CC), the base station apparatus comprising:
a notification unit configured to, in a case where system information that has been stopped from being transmitted on a second CC is transmitted on a first CC, notify the terminal apparatus, on the second CC, of information of a wireless resource in which the system information for the second CC is transmitted, the first CC and the second CC being included among the plurality of CCs.

2. The base station apparatus according to claim 1, wherein
the information of the wireless resource indicates that the system information for the second CC is transmitted on the first CC.

3. The base station apparatus according to claim 1, wherein
the information of the wireless resource indicates a frequency and time resource within the first CC in which the system information for the second CC is transmitted.

4. The base station apparatus according to claim 3, wherein
in a case where the system information for the second CC is transmitted in a plurality of frequency and time resources within the first CC, the terminal apparatus is notified of information that designates one frequency and time resource among the plurality of frequency and time resources as the information of the wireless resource, and
in the one frequency and time resource, another frequency and time resource among the plurality of frequency and time resources is designated.

5. The base station apparatus according to claim 3, wherein
in a case where the system information for the second CC is transmitted in a plurality of frequency and time resources within the first CC, the terminal apparatus is notified of information that designates the plurality of frequency and time resources as the information of the wireless resource.

6. The base station apparatus according to claim 1, wherein
the system information is a System Information Block Type1 (SIB1), and the information of the wireless resource is transmitted through a Master Information Block (MIB) in the second CC.

7. The base station apparatus according to claim 1, wherein
the system information is a Master Information Block (MIB) and a System Information Block Type1 (SIB1), and the information of the wireless resource is transmitted using a wireless resource within the second CC in which the MIB is transmitted in a case where transmission of the MIB is not stopped.

8. The base station apparatus according to claim 1, wherein
the system information is a Master Information Block (MIB) and a System Information Block Type1 (SIB1), and the information of the wireless resource is transmitted in a frequency range in which a synchronization signal is not transmitted out of orthogonal frequency division multiplexing (OFDM) symbols in which the synchronization signal is transmitted on the second CC.

9. The base station apparatus according to claim 1, further comprising:
a transmission unit configured to transmit the system information for the second CC on the first CC.

10. The base station apparatus according to claim 9, wherein
the system information includes a Master Information Block (MIB), a System Information Block Type1 (SIB1), and another SIB different from the SIB1, and
the base station apparatus transmits, on the first CC or the second CC, information indicating whether the other SIB is announced on the first CC to the terminal apparatus.

11. The base station apparatus according to claim 10, wherein
the transmission unit transmits the other SIB to the terminal apparatus on the first CC in a case where the other SIB is not announced on the first CC and the terminal apparatus has requested the other SIB.

12. The base station apparatus according to claim 10, wherein
a notification of the information indicating whether the other SIB is announced on the first CC is provided via SI-SchedulingInfo.

13. The base station apparatus according to claim 12, wherein
the information indicating whether the other SIB for the second CC is announced on the first CC includes information indicating whether the other SIB for the first CC is announced on the first CC.

14. A terminal apparatus in a wireless communication network that provides the terminal apparatus with a communication service with use of at least one of a plurality of component carriers (CC), the terminal apparatus comprising:
a reception unit configured to, in a case where a base station apparatus in the wireless communication network transmits on a first CC system information that has been stopped from being transmitted on a second CC, receive on the second CC information of a wireless resource in which the system information for the second CC is transmitted, and receive the system information for the second CC on the first CC on a basis of the information of the wireless resource, the first CC and the second CC being included among the plurality of CCs.

15. The terminal apparatus according to claim 14, wherein
the information of the wireless resource indicates that the system information for the second CC is transmitted on the first CC, and
the reception unit receives the system information for the first CC, and receives the system information for the second CC by specifying, based on the system information for the first CC, a frequency and time resource within the first CC in which the system information for the second CC is transmitted.

16. The terminal apparatus according to claim 14, wherein
the information of the wireless resource indicates a frequency and time resource within the first CC in which the system information for the second CC is transmitted, and
the reception unit receives the system information for the second CC in the frequency and time resource designated by the information of the wireless resource.

17. The terminal apparatus according to claim 16, wherein
in a case where the system information for the second CC is transmitted in a plurality of frequency and time resources within the first CC, the reception unit receives information that designates one frequency and time resource among the plurality of frequency and time resources as the information of the wireless resource, and
the reception unit further receives a part of the system information for the second CC in the one frequency and time resource, and receives another part of the system information for the second CC in another frequency and time resource which is included among the plurality of frequency and time resources and which is designated by the one frequency and time resource.

18. The terminal apparatus according to claim 16, wherein
in a case where the system information for the second CC is transmitted in a plurality of frequency and time resources within the first CC, the reception unit receives information that designates the plurality of frequency and time resources as the information of the wireless resource, and
the reception unit further receives different parts of the system information for the second CC respectively in the plurality of frequency and time resources.

19. The terminal apparatus according to claim 14, wherein
the system information is a System Information Block Type1 (SIB1), and the information of the wireless resource is received through a Master Information Block (MIB) in the second CC.

20. The terminal apparatus according to claim 14, wherein the system information is a Master Information Block (MIB) and a System Information Block Type1 (SIB1), and the information of the wireless resource is received in a wireless resource within the second CC in which the MIB is transmitted in a case where transmission of the MIB is not stopped.

21. The terminal apparatus according to claim 14, wherein
the system information is a Master Information Block (MIB) and a System Information Block Type1 (SIB1), and the information of the wireless resource is received in a frequency range in which a synchronization signal is not transmitted out of orthogonal frequency division multiplexing (OFDM) symbols in which the synchronization signal is transmitted on the second CC.

22. The terminal apparatus according to claim 14, wherein
the system information includes a Master Information Block (MIB), a System Information Block Type1 (SIB1), and another SIB different from the SIB1, and
the reception unit receives, on the first CC or the second CC, information indicating whether the other SIB is announced on the first CC from the base station apparatus.

23. The terminal apparatus according to claim 22, further comprising:
a request unit configured to request the base station apparatus to provide the other SIB in a case where the other SIB is not announced on the first CC,
wherein the reception unit receives, on the first CC, the other SIB transmitted from the base station apparatus on a basis of the request.

24. The terminal apparatus according to claim 22, wherein
the reception unit receives the information indicating whether the other SIB is announced on the first CC via SI-SchedulingInfo.

25. The terminal apparatus according to claim 24, wherein
the information indicating whether the other SIB for the second CC is announced on the first CC includes information indicating whether the other SIB for the first CC is announced on the first CC.

26. A control method executed by a base station apparatus in a wireless communication network that provides a terminal apparatus with a communication service with use of at least one of a plurality of component carriers (CC), the control method comprising:
in a case where system information that has been stopped from being transmitted on a second CC is transmitted on a first CC, notifying the terminal apparatus, on the second CC, of information of a wireless resource in which the system information for the second CC is transmitted, the first CC and the second CC being included among the plurality of CCs.

27. A control method executed by a terminal apparatus in a wireless communication network that provides the terminal apparatus with a communication service with use of at least one of a plurality of component carriers (CC), the control method comprising:
in a case where a base station apparatus in the wireless communication network transmits on a first CC system information that has been stopped from being transmitted on a second CC, receiving on the second CC information of a wireless resource in which the system information for the second CC is transmitted; and
receiving the system information for the second CC on the first CC on a basis of the information of the wireless resource, the first CC and the second CC being included among the plurality of CCs.
